(19) United States
(12) Patent Application Publication
(10) Pub. No.: US 2006/0172143 A1
(43) Pub. Date: Aug. 3, 2006

(54) Extrusion coating process and coated substrates having improved heat seal properties

(76) Inventors: David Ryan Breese, Loveland, OH (US); Richard T.E. Sylvester, Middletown, OH (US); Richard Knor, Centerville, OH (US)

Correspondence Address: WILLIAM A. HEIDRICH;Equistar Chemicals, LP, 11530 Northlake Drive, Cincinnati, OH, 45249, US

(21) Appl. No.: 11/352,620

(22) Filed: Feb. 13, 2006

Related U.S. Application Data
(63) Continuation-in-part of application No. 10/625,718, filed on Jul. 23, 2003, now abandoned.

(51) Int. Cl. C08L 33/04; B32B 27/00

(52) U.S. Cl. 428/500; 525/222

(57) ABSTRACT

An extrusion coating process for the production of extrusion coated substrates having improved heat seal properties at temperatures within the low heat seal range is provided. The process utilizes a combination of ethylene-vinyl acetate copolymers having different vinyl acetate contents.

### CROSS REFERENCE TO RELATED APPLICATIONS

This is a continuation-in-part application of U.S. Ser. No. 10/625,718 filed Jul. 23, 2003.

### BACKGROUND OF THE INVENTION

1. Field of the Invention

The present invention is directed to an extrusion coating process for the production of extrusion coated substrates having improved heat seal properties and to the resulting coated products. The process utilizes synergistic mixtures of ethylene-vinyl acetate copolymers having specific vinyl acetate contents and melt indexes to produce extrusion coated substrates having improved heat seals at low seal temperatures.

2. Description of the Prior Art

Heat sealable compositions are widely used to make packages from films, foils and papers. The packaging material substrate is extrusion coated on one side with the heat seal composition, the coated sides are then folded back on themselves and heat is applied in the intended seam areas to melt the heat seal composition and form the package seams.

In extrusion coating, a resin is melted and formed into a thin hot coating which is uniformly spread onto a moving substrate, such as paper, plastic film, metal foil or the like. The coated substrate is then passed between rolls which press the coating against the substrate to insure uniform contact of the coating layer and substrate and good adhesion after cooling. For most commercial extrusion coating applications, the coating resin will have a melt index from about 5 g/10 min up to about 40 g/10 min measured at 190° C. and 2.16 kg. This makes it possible for the molten resin exiting the extrusion coating die to be drawn down from the die into the nip between the two rolls below the die and uniformly drawn out to the desired thickness over the entire width of the substrate.

Ethylene-vinyl acetate (EVA) copolymers having MIs within the above-prescribed range, and more typically from 15 to 40 g/10 min., are commonly used as extrusion coatings to improve the appearance of substrate materials; provide improved tear, scuff or puncture resistance; provide grease, oil or chemical resistance; provide a moisture barrier; and, in some instances, provide a heat sealable surface layer.

For many commercial manufacturing processes, fast sealing capability at low temperatures with the formation of strong seals is essential. Whereas EVAs having higher vinyl acetate (VA) contents have low heat seal initiation temperatures, seal strengths are less than required for many applications. On the other hand, while lower VA content EVAs typically provide higher seal strengths, higher temperatures are required to develop these seals. The use of high temperatures to achieve acceptable seals requires more energy and can limit production rates. The use of high seal temperatures can also produce undesirable degradation of the seal material and, in some instances, the substrate material.

It would be highly advantageous for extrusion coating operations if it were possible to achieve high seal strengths, on the order of those typically achieved using low VA content EVAs, at lower heat seal temperatures. These and other advantages are achieved with the extrusion coating process of the present invention which uses a combination of EVA resins. By utilizing a mixture of specific high and low EVA resins to extrusion coat various substrates, it is possible to achieve an unexpected synergistic effect whereby at low heat seal temperatures it is possible to achieve seal strengths significantly higher than that achieved with either EVA component individually.

While mixtures of EVA resins have been used for the manufacture of heat sealable multi-layer films, they have typically been used for coextrusion processes wherein the molten EVA blend is extruded through a first extruder while concurrently melt extruding and layering with other molten resins being extruded from one or more other extruders.

For example, U.S. Pat. No. 3,817,821 discloses use of a blend of EVA resins for the production of laminar film structures having at least three layers using coextrusion processes. One of the coextruded layers is a blend of 20 to 40 weight percent (wt. %) polybutene-1 or EVA copolymer having a VA content of 35 to 70 wt. % with 60 to 80 wt. % EVA copolymer having a VA content of 5 to 28 wt. %

U.S. Pat. No. 4,247,584 discloses the use of EVA resin blends for the blown tubular coextrusion of heat shrinkable film laminates. EVA copolymers utilized for these blends are low melt index (MI) resins and the VA content of the resulting blends are relatively low. The blends are comprised of about 10 to 90 wt. % of a low VA content EVA copolymer containing about 2 to 12 percent VA and having a melt index of about 0.2 to 10 and about 90 to 10 wt. % of a high VA content EVA copolymer containing about 8 to 30 percent of VA and having a melt index of about 0.2 to 5. The MI of the blend will necessarily be less than 10 and the weight average VA content is specified to be from 4 to 15 percent.

Coextruded three-layer blown films wherein the inner, i.e. core, layer can be a blend of EVA resins are also disclosed in U.S. Pat. No. 4,082,877. EVA blends used contained equal parts EVAs each containing 28% VA and having melt indices of about 6 and 23-27, respectively.

U.S. Pat. No. 4,064,296 discloses coextruded films having a hydrolyzed EVA copolymer layer, i.e., EVOH, between two other polymer layers which can be EVA or an EVA blend. In one example, use of a blend of 75% EVA containing 3.5% VA and 25% EVA containing 9% VA to sandwich the EVOH layer is disclosed.

Blends of two polymeric materials, at least one of which has a melt flow substantially greater than that of any of the other materials, are disclosed in U.S. Pat. No. 4,178,401 for the production of coextruded “self-welding” packaging films. A blend of 95% EVA containing 18% VA and having a melt flow rate of 1.5 and 5% EVA containing 30% VA and having a melt flow of 150 is coextruded with an EVA containing 18% VA and having a melt flow of 0.8 to ultimately produce a 4-ply laminate.

Multilayer films having a heat sealable layer formed by coextruding a tube, preferably using the so-called double bubble process, are disclosed in U.S. Pat. No. 5,635,261. Preferred heat sealable layers are blends of a first EVA copolymer having an MI from 0.2 to 0.7 with a second EVA copolymer having an MI from 1 to 10. While the reference indicates the EVAs can have VA contents from 4 to 28%, it is preferred that the first EVA have a VA content of 10% and the second EVA have a VA content of 8.9%.

### SUMMARY OF THE INVENTION

An extrusion coating process and extrusion coated substrates having unexpected improved heat seal properties at temperatures within the low temperature heat seal range are provided. The process comprises providing a first EVA copolymer having a VA content from 9 to 20 wt. % and MI from 7 to 35 g/10 min; providing a second EVA copolymer having a VA content from 22 to 34 wt. % and MI from 7 to 35 g/10 min; combining said first and second EVA copolymers at a wt. ratio of 3:1 to 1:3 to produce a mixture having a VA content from 15 to 28 wt. % and a MI from 15 to 35 g/10 min; melt blending the mixture and extrusion coating at least one side of a substrate with the melt blend.

In a particularly preferred embodiment the first EVA copolymer has a VA content from 12 to 20 wt. %, the second EVA copolymer has a VA content from 24 to 32 wt. % and the mixture of first and second EVA copolymers has a VA content from 17 to 26 wt. % and MI from 17 to 32 g/10 min.

Extrusion coated substrates produced by the process which exhibit improved seal strengths at low heat seal temperatures include substrates selected from the group consisting of fabrics, paper products, plastic materials and metal foils. Extrusion coatings range in thickness from 0.2 to 1.5 mils.

### DETAILED DESCRIPTION OF THE INVENTION

The present invention relates to an improved extrusion coating process whereby the extrusion coated substrates produced have improved heat seal properties, namely the ability to obtain high seal strengths at temperatures in the low heat seal temperature range by using a specific combination of two different EVA copolymers which produce a synergistic effect. As referred to herein the terms low heat seal initiation temperature and in the low heat seal temperature range refer to heat seal temperatures of 170° F. or below.

For heat seal applications, the ability to achieve good seal strengths is paramount; however, there is increasing emphasis on the part of the packaging industry to increase -production rates and line speeds of packaging operations. Since the heat sealing step is typically the rate limiting step in such operations there is increased emphasis on developing sealing compositions which can achieve the desired seal strength at low heat seal initiation temperatures. This enables packagers to reduce the length of time the seal bars are in contact with the packaging material so that more units can be sealed in a given period of time. Additionally, it may be possible to reduce the temperature of the seal bars which will further improve the economics of the process.

Heretofore, in order to lower heat seal initiation temperatures and increase production, conventional practice has been to increase the VA content of the EVA heat seal resins used. This, however, limits the seal strength since, for reactor produced EVA resins, there is optimum seal strength at any given VA content.

With the process of the present invention we have unexpectedly found it is possible to achieve higher seal strengths at temperatures in the low heat seal temperature range utilizing a blend which is a combination of EVA copolymers. Surprisingly, a synergistic heat seal effect is obtained utilizing the specific combination of EVA copolymers employed for the invention. This synergist effect is the ability, at certain low heat seal temperatures, to achieve significantly stronger heat seals than can be obtained using either EVA component of the blend individually. Whereas the skilled artisan would not expect heat seal performance of an EVA blend at any given temperature to exceed that of the best performing EVA component in the blend, Applicants' have unexpectedly found that using the blends of the invention in their extrusion coating process, it is possible to achieve significant increases in seal strength at certain temperatures in the low heat seal temperature range.

The process of the invention whereby coated substrates having improved heat seal characteristics are produced entails combining a first EVA copolymer having a VA content from 9 to 20 wt. % and MI from 7 to 35 g/10 min and a second EVA copolymer having a VA content from 22 to 34 wt. % and MI from 7 to 35 g/10 min at a wt. ratio of the respective EVA components about 3:1 to 1:3 to produce a mixture having a VA content from 15 to 28 wt. % and MI from 15 to 35 g/10 min, melt blending the mixture and extrusion coating at least one side of a substrate with the molten EVA blend.

The first EVA copolymer utilized for the extrusion coating blends, also referred to herein as the low VA content copolymer, has a VA content of 9 to 20 wt. % and, more preferably, 12 to 20 wt. %. The second EVA copolymer, also referred to herein as the high VA content copolymer, will have a VA content of 22 to 34 wt. % and, more preferably, 24 to 32 wt. %. The low and high EVA components will be combined at a weight ratio of from 3:1 to 1:3 and, more preferably, from 2.5:1 to 1:2.5 to obtain the extrusion coating blends. Both the first and second EVA copolymers will have MIs from 7 to 35 g/10 min. MIs referred to herein are determined in accordance with ASTM D 1238-01, condition 190/2.16. All weight percentages referred to herein are based on the total weight of the composition.

The high and low VA content components are typically dry-blended at the desired weight ratio and then melt blended by conventional means, such as in an extruder or Banbury mixer. Melt blending is usually carried out at temperatures from about 300° F. up to about 400° F. The resulting melt blended composition may be directly extrusion coated onto the substrate or the blend may be pelletized and subsequently extrusion coated.

Blends useful for the extrusion coating process of the invention produced in the above manner from the prescribed high and low VA content EVA copolymers and in the prescribed ratios have VA contents (weight average) from 15 to 28 wt. % and MIs from 15 to 35 g/10 min. Preferably, VA contents of the blends are from 17 to 26 wt. % and blend MIs are preferably 17 to 32 g/10 min.

The compositions of the invention are suitable for the manufacture of extrusion coated articles using extrusion coating procedures known to the art. A comprehensive description of extrusion coating techniques and applications is provided in the technical manual published by Equistar Chemicals, LP entitled “A Guide to Polyolefin Extrusion Coating,” copyright 1997; 6664NV308/Reprint 12/97.

In general, extrusion coating comprises heating the polymer to be extruded to the desired temperature, usually in an extruder provided with a screw, and extruding it through a slot-shaped die onto the substrate to be coated. While in the molten state the polymer is drawn together with the substrate between a pair of rollers forming a nip. The rollers are biased towards each other to effect good contact of the molten polymer with the substrate. Normally the roller adjacent the polymer is cooled, for example by water, and the other roller is usually formed of a compressible material such as rubber. The cooled roller is generally maintained at a temperature below that at which the polymer sticks to avoid adhesion to that roller. The gap between the nip and die lip is adjusted to vary the draw ratio and the speed of rotation of the rollers and the extruder output are varied to control the thickness of the extrusion coating layer.

Extrusion coating includes extrusion lamination wherein the molten polymer is extruded between two substrates which then pass through the nip to form a laminated product in which the two substrates are bonded by the intervening extruded layer.

The extrusion coating method of the invention may be used at line speeds of up to about 3500 feet per minute or higher. More typical line speeds are 1000 to 2000 ft/min. Coating thicknesses can range from 0.2 to 1.5 mils and, more preferably, are from 0.4 to 1 mil.

Substrates advantageously extrusion coated by the process of the invention and which exhibit improved heat seal properties are selected from the group consisting of fabrics, paper products, plastic materials and metal foils. They include such diverse substrates as woven and nonwoven fabrics, fiber mats and webs, aluminum foil, metallized films, kraft paper, paperboard, regenerated cellulose films, polyethylene film, polypropylene film, polyester film, nylon film and the like. The process is particularly advantageous for extrusion coating mono- and multi-layer plastic films utilized for food packaging applications.

The following examples illustrate the improved extrusion coating process of the invention and the significantly improved heat seals obtained using the synergistic EVA blends. Those skilled in the art, however, will recognize numerous possible variations which are within the spirit of the invention and scope of the claims.

For the examples, the EVA extrusion coating blends were prepared by dry-blending the high and low VA content EVA resins. The resulting dry-blended EVA resin mixtures were then extrusion coated onto 2 mil poly(ethylene terephthalate) film (PET) for evaluation of heat sealability. Film width was 30 inches. Prior to coating, the PET film was surface treated to promote adhesion of the extrusion coatings. All of the surface treatments used were performed in-line with the extrusion coater and are conventional procedures typically used in commercial coating operations.

Extrusion coating was carried out on a commercial coating line operating at a rate of 300 feet per minute using a Beloit single screw extruder (L/D 24:1; screw speed 19 rpm) having five heating zones. Temperature profile within the extruder was as follows:
Zone 1: 275° F.
Zone 2: 325° F.
Zone 3: 400° F.
Zones 4 and 5: 450° F.
   The die temperature was 450° F. Thickness of the extrusion coating was 0.5 mil. After application of the extrusion coating the coated film was passed through a chill roll maintained at approximately 60° F.

Extrusion coated PET films were evaluated to determine the strength of heat seals developed at various temperatures within the low temperature heat seal temperature range in accordance with ASTM Test Method F88-94. This procedure is used to measure the seal strength of flexible barrier materials and, more specifically, the force required to tear apart a seal of standard width. For the test, fin seal test specimens were cut from the extrusion coated PET films and sealed using a Sencorp Model 12 ASL/1 heat sealer for 0.5 seconds and 40 psi. Both jaws were heated. After conditioning, the test specimens were pulled in a tensile testing machine at a rate of 20 inches/minute. The maximum force required to cause seal failure at a given seal temperature is reported as the seal strength. Seal strengths are expressed in pounds-force per inch of width and are the average of 5 replicates. Heat sealing at 0.5 seconds and 40 psi is considered to be representative of conditions typically employed by the industry for commercial heat sealing operations.

### EXAMPLE 1

For this example, a blend of high and low VA content EVA resins was prepared by dry blending an EVA copolymer having a VA content of 28% and an EVA copolymer containing 18% VA at a ratio of 2.33:1 (wt. ratio of high VA content EVA to low VA content EVA). The MI of both EVAs was 26 g/10 min. The resulting EVA blend had a weight average VA content of 25 wt. % and MI of 26 g/10 min and was extrusion coated onto PET film coated with a water-based primer (MICA A131), corona treated and ozonated prior to application of the extrusion coating. The extrusion coated PET films were heat sealed at 5° F. temperature intervals over the range 125° F. to 170° F. and results were as follows:

| Seal Temperatures (° F.) | Seal Strength (lbs) |
|---|---|
| 125 | 0.3 |
| 130 | 1.1 |
| 135 | 1.8 |
| 140 | 2.2 |
| 145 | 3.2 |
| 150 | 3.7 |
| 155 | 4.8 |
| 160 | 5.6 |
| 165 | 6.9 |
| 170 | SO |

For comparison the same PET film, identically pre-treated, was extrusion coated using the same extrusion conditions, with the high VA content EVA copolymer, by itself, and the low VA content EVA copolymer, by itself. The resulting extrusion coated PET films were evalutaed for seal strength over the same seal temperature range and the results are tabulated below.

| | Seal Strength (lbs) | |
|---|---|---|
| Seal | PET Coated with High | PET Coated with Low |
| Temperature (° F.) | VA Content EVA | VA Content EVA |
| 125 | 0.4 | NS |
| 130 | 0.8 | NS |
| 135 | 1.8 | NS |
| 140 | 2.5 | NS |
| 145 | 3.1 | NS |
| 150 | 3.0 | NS |
| 155 | 2.8 | 0.6 |
| 160 | 3.3 | 1.8 |
| 165 | SO | 2.8 |
| 170 | SO | 4.1 |

“NS” indicates that no heat seal was obtained at the specified temperature and the notation “SO” signifies “squeeze out.” Squeeze out is an art recognized phenomenon for an unsatisfactory condition which occurs when heat sealing EVA resins at temperatures above optima where, due to the temperature-viscosity relationship of the coating resin, it becomes so fluid that the pressure of the seal bars causes the coating to be squeezed out of the area to be sealed leaving an inadequate amount of material to form a seal.

Comparing the heat seal results obtained over the seal temperature range 125-170° F. using the EVA blends versus the results obtained over the same temperature range using the individual EVA components, the synergistic improvement in seal strengths achieved at 150-165° F. is immediately apparent. At 150° F., for example, where the low VA component individually produces no seal and the high VA component used by itself gives a seal strength of 3 lbs., the blend of the invention unexpectedly has a seal strength of 3.7 lbs. While one skilled in the art would not expect the seal strength of the EVA blend to exceed that of the best EVA component in the blend, surprisingly there is a 23% increase in seal strength over that obtained when using the high VA content EVA by itself. The improvement obtained using the blends at heat seal temperatures of 155° F., 160° F. and 165° F. are even more pronounced, i.e., 71%, 69% and 146%, respectively, higher than the highest heat seal value obtained using either EVA component by itself.

While synergistic heat seal improvement is not exhibited over the entire low heat seal temperature range, the improvement obtained at 150-165° F. is unexpected and significant. Furthermore, by judicious selection of the first and/or second EVA components comprising the blends and/or by varying the weight ratio of the high and low VA content EVA components it is possible to design EVA extrusion coating blends for use in the process which give synergistic heat seal improvement at different heat seal temperatures. The following example demonstrates this ability by varying the weight ratio of the EVA components.

### EXAMPLE 2

Using the high and low VA content EVAs of Example 1, an EVA blend was prepared by dry-blending these components at a ratio of 1:2.33 (wt. ratio of high to low VA content EVAs). This blend was extrusion coated onto PET film and heat seal characteristics determined over the temperature range 125-170° F. in accordance with the procedures of Example 1. Heat seal results were as follows:

| Seal Temperatures (° F.) | Seal Strength (lbs) |
|---|---|
| 125 | NS |
| 130 | NS |
| 135 | 0.4 |
| 140 | 1.0 |
| 145 | 1.7 |
| 150 | 2.1 |
| 155 | 2.2 |
| 160 | 4.4 |
| 165 | 5.4 |
| 170 | 6.7 |

As will be observed from the data by varying the weight ratio of components, the ability to highly effective heat seals was shifted to higher temperatures. Whereas the highest heat seal value obtained using the blend of Example 1 was at 165° F. and squeeze out occurred at 170° F. with the blend of Example 2, optimal seal strength was achieved at 170° F. With the blend of this example, significant synergistic improvement in seal strength over that obtained using the individual EVA components was obtained at 160° F., 165° F. and 170° F.

### COMPARATIVE EXAMPLE 3

An EVA blend was prepared and extrusion coated on PET film; however, the blend utilized a weight ratio of high to low VA content EVA resins outside the scope of the invention. The weight ratio of high to low EVA components was 3.35:1. The high VA content EVA was the same as used in Example 1 and the low VA content EVA contained 15% EVA and had an MI of 26 g/10 min. Heat seal strengths of PET film surface treated by corona and ozone treatment and extrusion coated with the comparative blends are tabulated below for the temperature range 125-170° F. Results are the average of runs made using two different lots of the same low VA content EVA. Also included in the table are the results obtained for PET film coated with the high and low VA content EVAs individually.

| | Seal Strength (lbs) | | |
|---|---|---|---|
| | | PET Coated | |
| Seal | PET Coated | with Low | PET Coated |
| Temperature | with EVA | VA Content | with High VA |
| (° F.) | Blend | EVA | Content EVA |
| 125 | 0.15 | NS | 0.4 |
| 130 | 0.6 | NS | 0.8 |
| 135 | 1.25 | NS | 1.8 |
| 140 | 1.9 | NS | 2.5 |
| 145 | 2.8 | NS | 3.1 |
| 150 | 3.25 | NS | 3.0 |
| 155 | SO | 0.4 | 2.8 |
| 160 | SO | 1.15 | 3.3 |
| 165 | SO | 2 | SO |
| 170 | SO | 2.85 | SO |

It is apparent from the above results that heat seals obtained using EVA blends wherein the weight ratio of the high and low VA content EVA components are outside the range of the process of the invention provide little or no improvement over the use of either EVA component itself.

We claim:

1. In a process for the production of heat sealable extrusion coated substrates having improved heat seal properties, the process comprising:
(a) providing a first EVA copolymer having a VA content from 9 to 20 wt. % and MI from 7 to 35 g/10 min;
(b) providing a second EVA copolymer having a VA content from 22 to 34 wt. % and MI from 7 to 35 g/10 min;
(c) combining said first and second EVA copolymers at a wt. ratio of 3:1 to 1:3 to produce a mixture having a VA content from 15 to 28 wt. % and MI from 15 to 35 g/10 min;
(d) melt blending the mixture obtained from step (c); and
(e) extrusion coating at least one side of a substrate with the melt blended product produced in step (d).

2. The process of claim 1 wherein the first EVA copolymer has a VA content from 12 to 20 wt. %.

3. The process of claim 1 wherein the second EVA copolymer has a VA content from 24 to 32 wt. %.

4. The process of claim 1 wherein the first and second EVA copolymers are combined at a weight ratio of 2.5:1 to 1:2.5.

5. The process of claim 4 wherein the mixture of first and second EVA copolymers has a VA content from 17 to 26 wt. % and MI from 17 to 32 g/10 min.

6. An extrusion coated substrate produced by the process of claim 1 and further characterized by having improved heat seal properties in the low heat seal temperature range.

7. The extrusion coated substrate of claim 6 wherein the extrusion coating is applied to a thickness of 0.2 to 1.5 mils and the substrate is selected from the group consisting of fabrics, paper products, plastic materials and metal foils.

8. The extrusion coated substrate of claim 7 wherein the extrusion coating is a blend of first and second EVA copolymers having an MI from 17 to 32 g/10 min and weight average VA content from 17 to 26 wt. %.

9. The extrusion coated substrate of claim 8 wherein the first EVA copolymer has a VA content from 12 to 20 wt. % and the second EVA copolymer has a VA content from 24 to 32 wt. %.

10. The extrusion coated substrate of claim 8 wherein the first and second EVA copolymers are combined at a weight ratio of 2.5:1 to 1:2.5.
